(19) United States
(12) Patent Application Publication
(10) Pub. No.: US 2023/0172127 A1
(43) Pub. Date: Jun. 8, 2023

(54) PLANT GROWING APPLIANCE WITH A CAMERA

(71) Applicant: Haier US Appliance Solutions, Inc., Wilmington, DE (US)

(72) Inventors: Christopher Hayward Osborne, Louisville, KY (US); John Alexander Gardner, Louisville, KY (US)

(21) Appl. No.: 17/540,785

(22) Filed: Dec. 2, 2021

(51) Int. Cl. A01G 31/06; H04N 5/232; H04N 5/225

(52) U.S. Cl. CPC A01G 31/06; H04N 5/23299; H04N 5/2256; H04N 5/23296

(57) ABSTRACT

A plant growing appliance includes a cabinet. A tower is rotatably mounted within a grow chamber of the cabinet. The tower has a plurality of grow sections that are circumferentially spaced on the tower. Each of the plurality of grow sections defines a respective plurality of apertures for receiving one or more plant pods. A height of each of the plurality of grow sections is no less than sixty centimeters. A single camera is mounted to cabinet. The single camera is positioned and oriented for capturing an image of the height of each of the plurality of grow sections.

### FIELD OF THE INVENTION

The present subject matter relates generally to systems for gardening plants indoors.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Monitoring plant growth within such indoor garden centers can be difficult. For instance, user may travel for a period of time and be unable to directly observe plants within the indoor garden centers. An indoor garden center with features for allowing a user to monitor plant growth within the indoor garden center would be useful.

### BRIEF DESCRIPTION OF THE INVENTION

Aspects and advantages of the invention will be set forth in part in the following description, or may be apparent from the description, or may be learned through practice of the invention.

In one example embodiment, a plant growing appliance includes a cabinet. A tower is rotatably mounted within a grow chamber of the cabinet. The tower has a plurality of grow sections that are circumferentially spaced on the tower. Each of the plurality of grow sections defines a respective plurality of apertures for receiving one or more plant pods. A height of each of the plurality of grow sections is no less than sixty centimeters. A single camera is mounted to cabinet. The single camera is positioned and oriented for capturing an image of the height of each of the plurality of grow sections.

In another example embodiment, A plant growing appliance includes a cabinet. A tower is rotatably mounted within a grow chamber of the cabinet. The tower has a plurality of grow sections that are circumferentially spaced on the tower. Each of the plurality of grow sections defines a respective plurality of apertures for receiving one or more plant pods. A height of each of the plurality of grow sections is no less than sixty centimeters. A motor is coupled to the tower. The motor is operable to rotate the tower within the cabinet. A light emitter is positioned at the growth chamber. The light emitter is operable to illuminate at least a portion of the growth chamber. A single camera is mounted to cabinet. The single camera is positioned and oriented for capturing an image of the height of each of the plurality of grow sections. A controller is in operative communication with the motor, the light emitter, and the single camera. The controller is configured for triggering the single camera in response to the tower rotating a threshold angle from a home position of the tower. The controller is also configured to activate the light emitter when the camera captures the image.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a gardening appliance according to an example embodiment of the present subject matter.

FIG. 2 is a front view of the example gardening appliance of FIG. 1 with the doors shown open.

FIG. 3 is a section view of the example gardening appliance of FIG. 1, taken along the 3-3 section line in FIG. 2 and with an internal divider removed for clarity.

FIG. 4 is a top perspective view of the example gardening appliance of FIG. 1, with the top panel of the cabinet removed to reveal a rotatable grow module.

FIG. 5 is a perspective section view of the example gardening appliance of FIG. 1.

FIG. 6 is a perspective view of the grow module of the example gardening appliance of FIG. 1.

FIG. 7 is a perspective section view of the example grow module of FIG. 6.

FIG. 8 is a top section view of the example grow module of FIG. 6.

FIG. 9 is a partial perspective view of the example gardening appliance of FIG. 1 and shows a camera of the example gardening appliance.

FIG. 10 is a partial section view of the example gardening appliance of FIG. 1 and shows the camera of the example gardening appliance.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

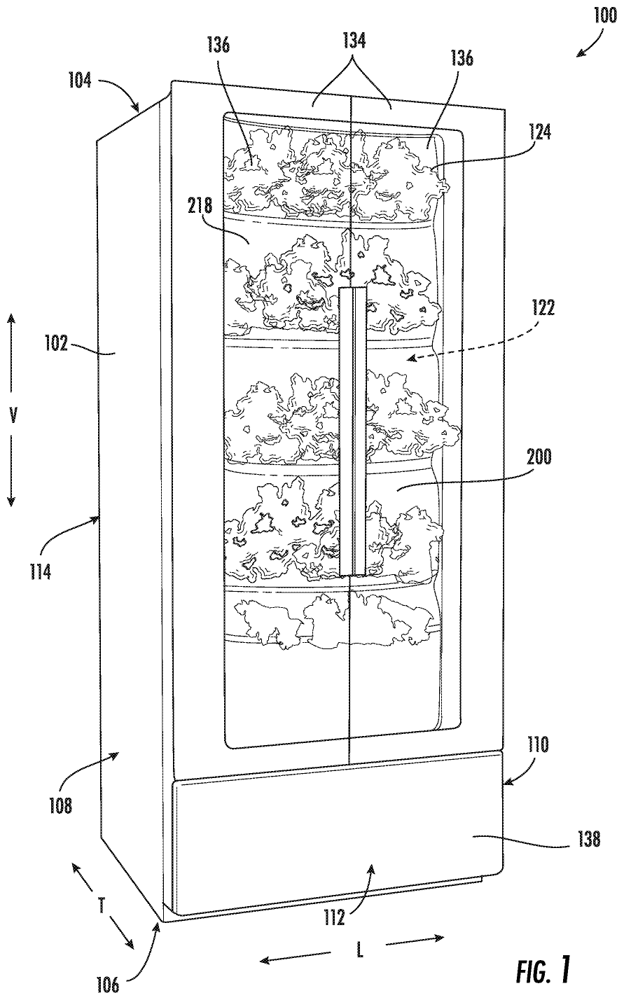

FIG. 1 provides a front view of a gardening appliance 100 according to an example embodiment of the present subject matter. According to example embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top portion 104 and a bottom portion 106 along a vertical direction V, between a first side portion 108 and a second side portion 110 along a lateral direction L, and between a front portion 112 and a rear portion 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled chamber, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an example embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

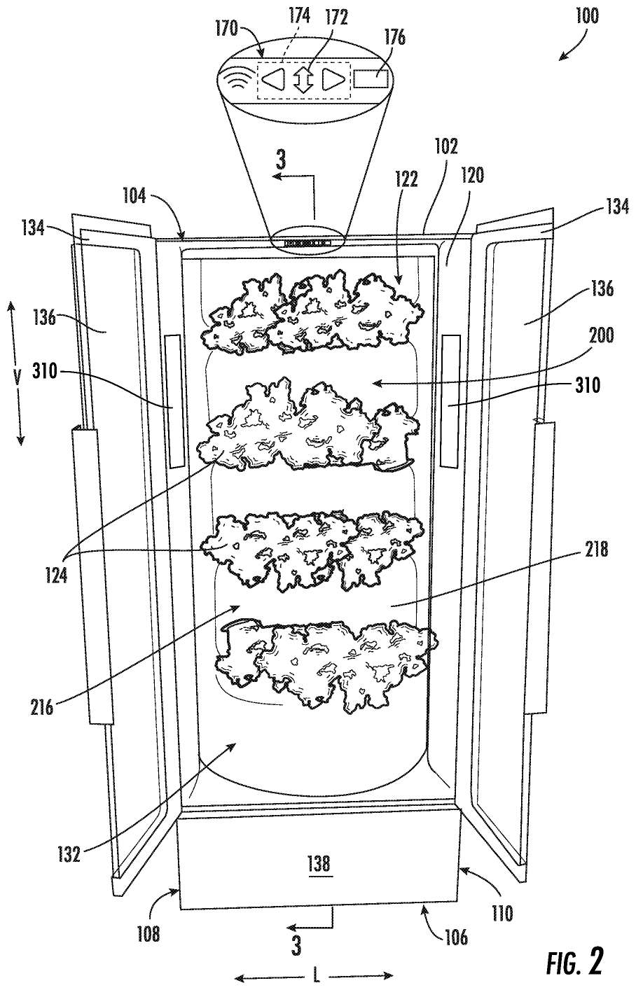

Gardening appliance 100 may further include one or more doors 134 that are rotatably mounted to cabinet 102 for providing selective access to grow chamber 122. For example, FIG. 1 illustrates doors 134 in the closed position such that doors 134 may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative example embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated example embodiment, gardening appliance 100 further includes a drawer 138 positioned proximate bottom 106 of cabinet 102 and being slidably mounted to cabinet 102 for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

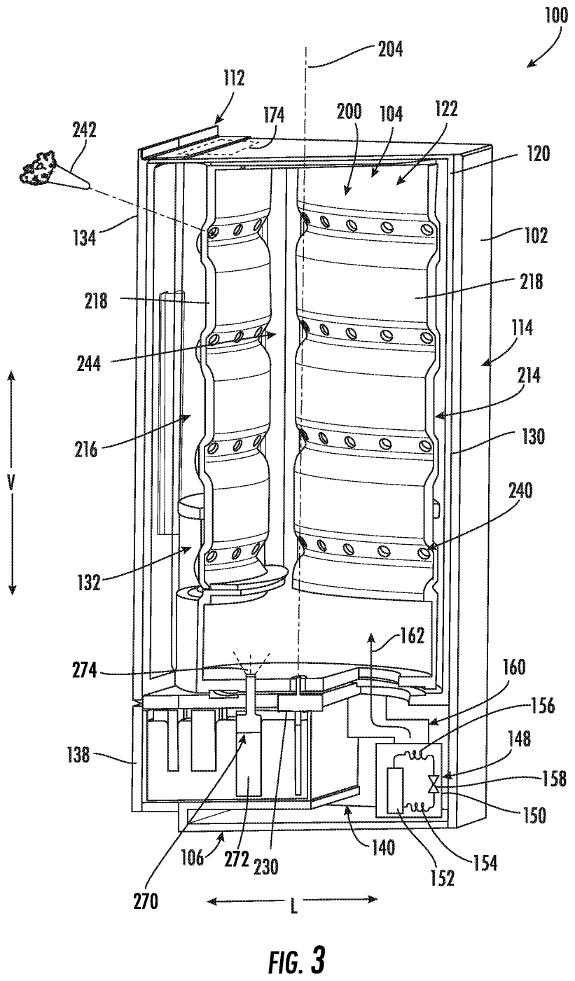

FIG. 3 provides a schematic view of certain components of an environmental control system 148 that may be used to regulate a temperature within grow chamber 122. Specifically, environmental control system 148 may include a sealed system 150, a duct system 160, and a hydration system 270, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an example sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated example embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

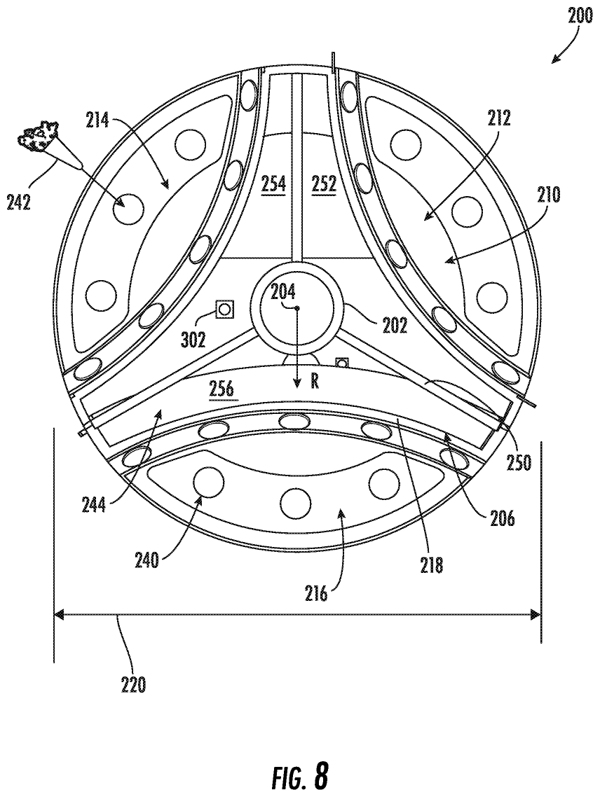

Referring now generally to FIGS. 1 through 8, gardening appliance 100 generally includes a rotatable tower or carousel, referred to herein as a grow module 200 that is mounted within liner 120, e.g., such that grow module 200 is within grow chamber 122. As illustrated, grow module 200 includes a central hub 202 that extends along and is rotatable about a central axis 204. Specifically, according to the illustrated example embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g., in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. For instance, grow module 200 may include three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction R, it should be appreciated that they need not be entirely radially extending. For example, according to the illustrated example embodiment, the distal ends of each partition 206 is joined with an adjacent partition 206 using an arcuate wall 218, which is generally used to support plants 124.

Notably, it is desirable according to example embodiments to form a substantial seal between partitions 206 and liner 120. Therefore, according to an example embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an example embodiment, motor 230 may be operably coupled to controller 174, which is programmed to rotate grow module 200 according to predetermined operating cycles, based on user inputs (e.g., via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an example embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g., when viewed from a top of grow module 200) in one hundred and twenty degree (120°) increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

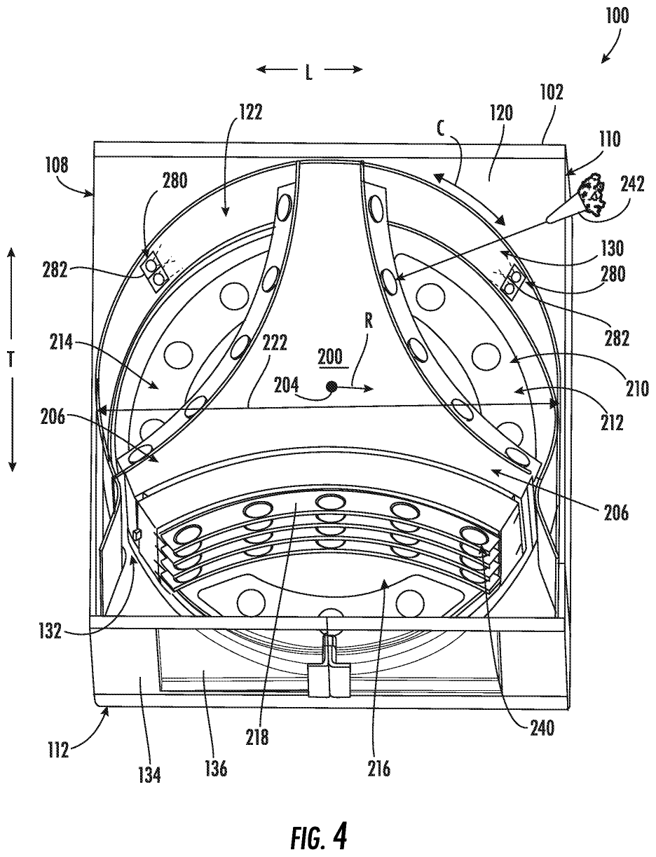

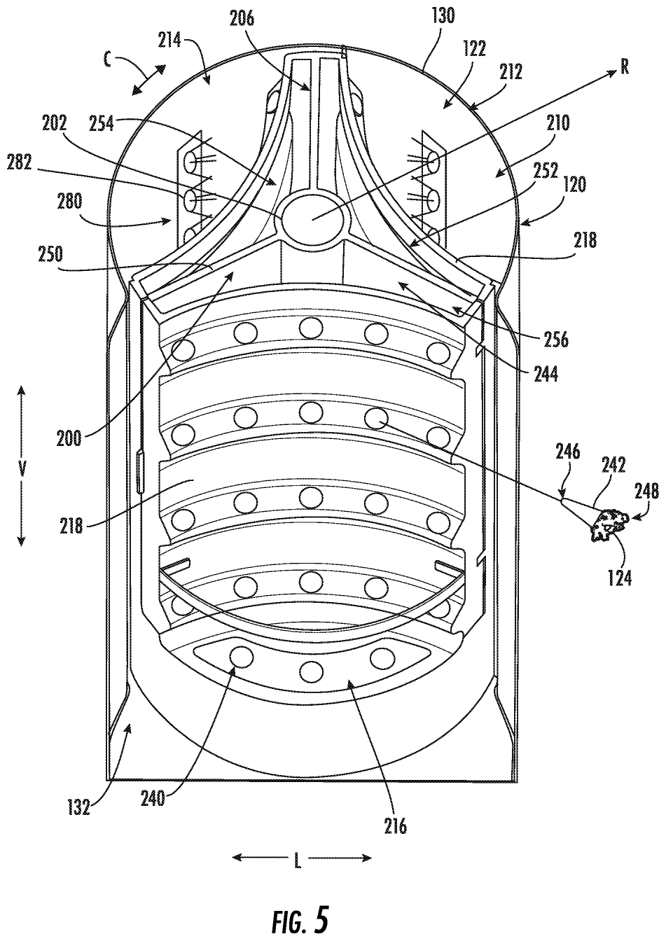

For example, as illustrated in FIGS. 4 and 5, first chamber 212 and second chamber 214 are both in a sealed position, whereas third chamber 216 is in a display position. As motor 230 rotates grow module 200 by one hundred and twenty degrees (120°) in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an example embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

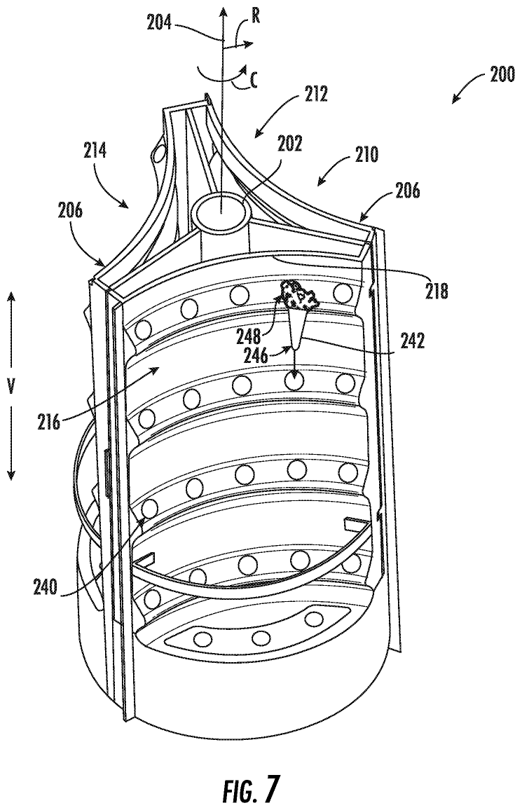

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an example embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

As best shown in FIG. 3, environmental control system 148 may further include a hydration system 270 which is generally configured for providing water and/or nutrients to plants 124 to support their growth. Specifically, according to the illustrated embodiment, hydration system 270 may be fluidly coupled to a water supply and or nutrient distribution assembly to selectively provide desirable quantities and concentrations of hydration, nutrients, and/or other fluids onto plants to facilitate improved plant growth. For example, hydration system 270 includes a water supply 272 and misting device 274 (e.g., such as a fine mist spray nozzle or nozzles). For example, water supply 272 may be a reservoir containing water (e.g., distilled water) or may be a direct connection municipal water supply. According to example embodiments, hydration system 270 may include one or more pumps (not shown) for providing a flow of liquid nutrients to misting device 274. In this regard, for example, water or nutrients that are not absorbed by roots of plants 124 may fall under the force of gravity into a sump and these pumps may be fluidly coupled to the sump to recirculate the water through misting device 274.

Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

As explained above, light generated from light assembly 280 may result in light pollution within a room where gardening appliance 100 is located. Therefore, aspects of the present subject matter are directed to features for reducing light pollution, or to the blocking of light from light sources 282 through front display opening 132. Specifically, as illustrated, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out through front display opening 132. As grow module 200 rotates, two of the three grow chambers 210 will receive light from light assembly 280 at a time. According to still other embodiments, a single light assembly may be used to reduce costs, whereby only a single grow chamber 210 will be lit at a single time.

Gardening appliance 100 and grow module 200 have been described above to explain an example embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by one hundred and eighty degrees (180°) about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

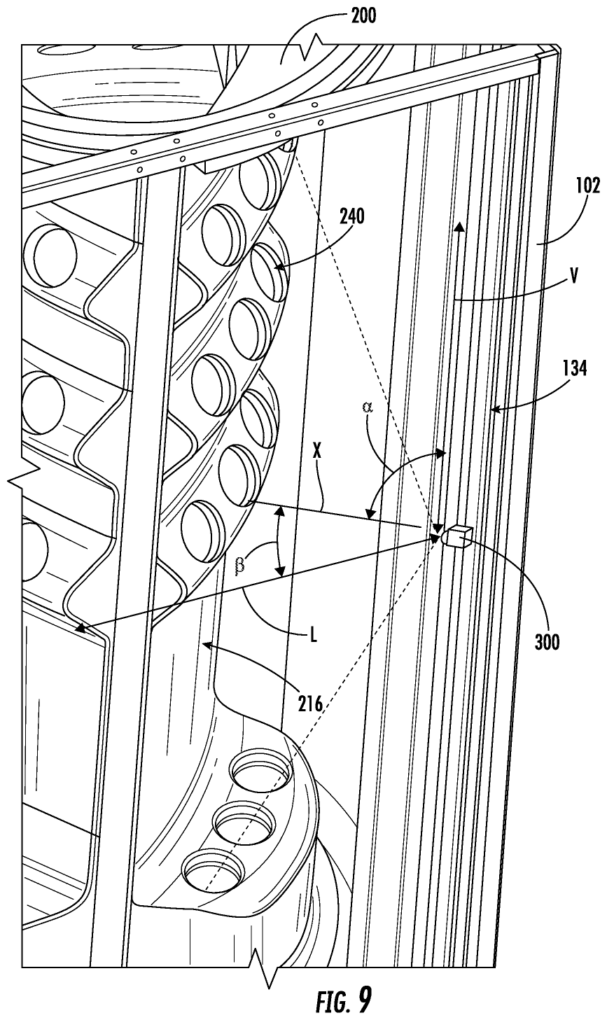

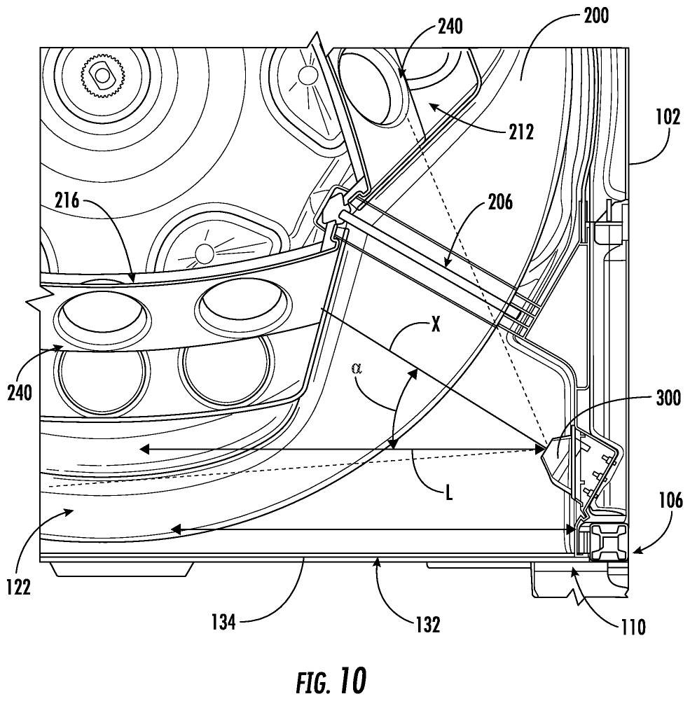

As discussed in greater detail below, a user of gardening appliance 100 may desire to monitor of observe plants within grow chamber 122, e.g., remotely. Thus, gardening appliance 100 includes features for capturing image(s) of grow chamber 122. In particular, turning to FIGS. 9 and 10, gardening appliance 100 includes a single camera 300 mounted to cabinet 102 that is configured for capturing image(s) of each grow chamber 212-216. Moreover, as grow module 200 rotates within cabinet 102, the single camera 300 may capture image(s) of each grow chamber 212-216.

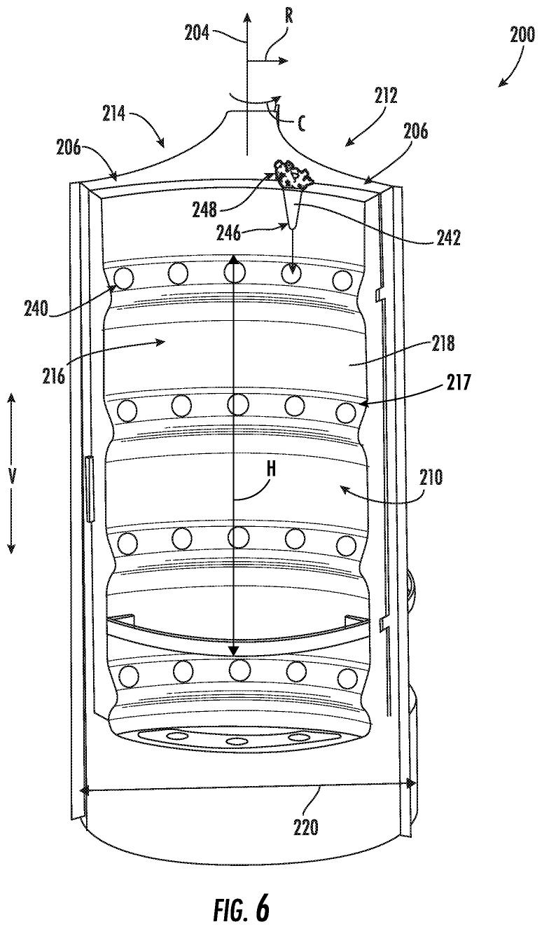

As shown in FIG. 6, third chamber 216 has a growth section 217 between the lowermost apertures 240, e.g., proximate bottom portion 106 of cabinet 102 and the uppermost apertures 240, e.g., proximate top portion 104 of cabinet 102. Thus, growth section 217 of third chamber 216 may extend along the vertical direction V to include all apertures 240 in third chamber 216. It will be understood that, while only growth section 217 of third chamber 216 is shown in FIG. 6, each of first and second chambers 214, 216 may also include a respective growth section that extends along the vertical direction V to include the apertures 240 in first and second chambers 212, 214. Moreover, the description of the growth section 217 of third chamber 216 provided below is equally applicable to the growth sections of first and second chambers 212, 214 and is not repeated herein for the sake of brevity.

Apertures 240 in growth section 217 of third chamber 216 may include no less than three rows of apertures 240, e.g., distributed along the vertical direction V. Growth section 217 of third chamber 216 may have a height H, e.g., along the vertical direction V. In general, the height H of growth section 217 of third chamber 216 may be no less than sixty centimeters (60 cm). Moreover, the height H of growth section 217 of third chamber 216 may be no greater than two hundred centimeters (200 cm). In certain example embodiments, the height H of growth section 217 of third chamber 216 may be no less than seventy centimeters (70 cm) and no greater than one hundred and twenty centimeters (120 cm). In various example embodiments, the height of the growth sections of first, second, and third chambers 212-216 may be uniform or may vary.

As noted above, gardening appliance 100 includes a single camera 300 for capturing images of chambers 212-216. Moreover, the single camera 300 may be positioned and oriented for capturing image(s) of the entire height of each grow section of chambers 212-216. For example, single camera 300 may be positioned and oriented for capturing an image of the entire height and/or width of grow section 217 of third chamber 216 when third chamber 216 is rotated to face the single camera 300. By using a single camera rather than multiple camera, costly components may be omitted from gardening appliance 100. Moreover, complex image processing may be avoided. However, grow module 200 is tall and thus elongated along the vertical direction V, and the single camera 300 may be positioned in close proximity to grow module 200 within cabinet 102, e.g., no more than thirty centimeters (30 cm), no more than twenty-five centimeters (25 cm), no more than twenty centimeters (20 cm), etc. from grow module 200. Thus, capturing image(s) of plants with all apertures 240 in each of first, second, and third chambers 212-216 can be difficult. The single camera 300 may also include a wide-angle curvilinear lens. The position, orientation, and/or lens selection of the single camera 300 can facilitate capturing image(s) of the entire height and/or width (e.g., along the radial direction R) of each grow section of chambers 212-216 with the single camera 300.

As a particular example, the single camera 300 may be positioned on cabinet 102 within a top half of growth chamber 122. Moreover, the single camera 300 may be positioned on cabinet 102 within a top third of growth chamber 122. Accordingly, the single camera may be positioned above a middle of growth chamber 122, e.g., along the vertical direction V. The single camera 300 may also be positioned at or proximate front display opening 132 and/or the display position for grow module 200. The single camera 300 may also be oriented such that an optical axis X of the single camera 300 defines an angle α with the vertical direction V. The angle α may be no less than five degrees (5°) and no greater than twenty degrees (20°). For instance, the angle α may be about ten degrees (10°). The single camera may be further oriented such that the optical axis X of the single camera 300 defines an angle β with the lateral direction L. The angle β is no less than thirty degrees (30°) and no greater than sixty degrees (60°). For instance, the angle β may be about forty-five degrees (10°). Such positioning and/or orientation of the single camera 300 may advantageously allow the single camera 300 to capture image(s) of the entire height and/or width of each grow section of chambers 212-216.

Controller 174 may be in operative communication with single camera 300. Moreover, controller 174 may be configured for triggering single camera 300 in response to grow module 200 rotating a threshold angle from a home position of grow module 200. For instance, when grow module 200 is positioned such that third chamber 216 is in the display position, controller 174 may activate motor 230 and then trigger single camera 300 to capture an image after grow module 200 rotates about twenty degrees (20°) from the display position for third chamber 216 Such delayed triggering may facilitate taking images of the grow sections of chambers 212-216 when such portions of grow module 200 are positioned about normal to optical axis of the single camera 300, e.g., in plane that is perpendicular to the vertical direction V.

Gardening appliance 100 may also include a light emitter 310 (FIG. 1) positioned at growth chamber 122. Light emitter 310 may be operable to illuminate at least a portion of growth chamber 122. For instance, light emitter 310 may be positioned at or proximate front display opening 132 and/or the display position for grow module 200. Light emitter 310 may be user operable to illuminate the front display opening 132 and/or the display position for grow module 200. For example, controller 174 may activate light emitter 310 in response to the user of gardening appliance 100 actuating a light input of input selectors 172 on control panel 170. In addition, controller 174 may activate light emitter 310 when the single camera 300 captures an image. Thus, light emitter 310 may illuminate the field of view of the single camera 300 and/or act as a flash for the single camera 310. Light emitter 310 may include light emitters on both sides of front display opening 132 and/or the display position for grow module 200, e.g., along the lateral direction L, at a top of front display opening 132 and/or the display position for grow module 200, etc.

Pictures from single camera 300 may be transmitted to a user of gardening appliance 100. For instance, images taken by single camera 300 may be uploaded to a cloud-server and then subsequently viewed by the user on a remote client, such as a smartphone. By only using single camera 300, significant data savings may be realized while allowing the user to see chambers 212-216.

As may be seen from the above, gardening appliance 100 may assist with growing plants indoors via a central rotating grow module 200. A camera may be positioned on side of the cabinet 102, e.g., at a particular angle and/or distance from the grow module 200. Thus, a single camera rather than multiple cameras may be used to capture image(s) of all plants on the grow module 200 along the vertical direction V on the portion of grow module 200 proximate the single camera as the grow module 200 rotates. Motor position signal feedback may be used to determine the exact rotational position of grow module 200 for timing the image capture with the single camera. The images captured with the single camera may be stored within a memory on the gardening appliance 100, in the cloud, on an app, etc.

By using the single camera, system complexity can be significantly reduced compared to multi-camera designs, e.g., due to reduced wiring or removal of a USB hub. Moreover, minimal to zero post processing may be required of images from the single camera 300 due to the above-described positioning of the single camera. For instance, image distortion correction and image stitching may not be required since the entire vertical height and/or radial width of the growth sections is captured at once with the single camera.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A plant growing appliance, comprising:
a cabinet;
a tower rotatably mounted within a growth chamber of the cabinet, the tower having a plurality of grow sections that are circumferentially spaced on the tower, each of the plurality of grow sections defining a respective plurality of apertures for receiving one or more plant pods, a height of each of the plurality of grow sections being no less than sixty centimeters; and
a single camera mounted to cabinet, the single camera positioned and oriented for capturing an image of the height of each of the plurality of grow sections.

2. The plant growing appliance of claim 1, wherein the single camera is positioned on the cabinet within a top half of the growth chamber.

3. The plant growing appliance of claim 2, wherein the single camera is oriented such that an optical axis of the single camera defines an angle α with a vertical axis, and the angle α is no less than five degrees and no greater than twenty degrees.

4. The plant growing appliance of claim 2, wherein the single camera is oriented such that an optical axis of the single camera defines an angle β with a lateral axis, and the angle β is no less than thirty degrees and no greater than sixty degrees.

5. The plant growing appliance of claim 1, wherein:
the single camera is oriented such that an optical axis of the single camera defines an angle α with a vertical axis, and the angle α is no less than five degrees and no greater than twenty degrees; or
the single camera is oriented such that the optical axis of the single camera defines an angle β with a lateral axis, and the angle β is no less than thirty degrees and no greater than sixty degrees; or
both the single camera is oriented such that the optical axis of the single camera defines the angle α with the vertical axis and the optical axis of the single camera defines the angle β with the lateral axis.

6. The plant growing appliance of claim 1, wherein the plurality of apertures in each of the plurality of grow sections comprises no less than three rows of apertures.

7. The plant growing appliance of claim 1, further comprising a motor coupled to the tower, the motor operable to rotate the tower within the cabinet.

8. The plant growing appliance of claim 7, further comprising a controller in operative communication with the motor and the single camera, the controller configured for triggering the single camera in response to the tower rotating a threshold angle from a home position of the tower.

9. The plant growing appliance of claim 1, further comprising a light emitter positioned at the growth chamber, the light emitter operable to illuminate at least a portion of the growth chamber.

10. The plant growing appliance of claim 9, further comprising a controller in operative communication with the light emitter and the single camera, the controller configured to activate the light emitter when the single camera captures the image.

11. The plant growing appliance of claim 1, wherein the single camera comprises a wide-angle curvilinear lens.

12. A plant growing appliance, comprising:
a cabinet;
a tower rotatably mounted within a growth chamber of the cabinet, the tower having a plurality of grow sections that are circumferentially spaced on the tower, each of the plurality of grow sections defining a respective plurality of apertures for receiving one or more plant pods, a height of each of the plurality of grow sections being no less than sixty centimeters;
a motor coupled to the tower, the motor operable to rotate the tower within the cabinet;
a light emitter positioned at the growth chamber, the light emitter operable to illuminate at least a portion of the growth chamber;
a single camera mounted to cabinet, the single camera positioned and oriented for capturing an image of the height of each of the plurality of grow sections; and
a controller in operative communication with the motor, the light emitter, and the single camera, the controller configured for triggering the single camera in response to the tower rotating a threshold angle from a home position of the tower, the controller also configured to activate the light emitter when the single camera captures the image.

13. The plant growing appliance of claim 12, wherein the single camera is positioned on the cabinet within a top half of the growth chamber.

14. The plant growing appliance of claim 13, wherein the single camera is oriented such that an optical axis of the single camera defines an angle α with a vertical axis, and the angle α is no less than five degrees and no greater than twenty degrees.

15. The plant growing appliance of claim 14, wherein the single camera is oriented such that an optical axis of the single camera defines an angle β with a lateral axis, and the angle β is no less than thirty degrees and no greater than sixty degrees.

16. The plant growing appliance of claim 12, wherein:
the single camera is oriented such that an optical axis of the single camera defines an angle α with a vertical axis, and the angle α is no less than five degrees and no greater than twenty degrees; or
the single camera is oriented such that the optical axis of the single camera defines an angle β with a lateral axis, and the angle β is no less than thirty degrees and no greater than sixty degrees; or
both the single camera is oriented such that the optical axis of the single camera defines the angle α with the vertical axis and the optical axis of the single camera defines the angle β with the lateral axis.

17. The plant growing appliance of claim 12, wherein the plurality of apertures in each of the plurality of grow sections comprises no less than three rows of apertures.

18. The plant growing appliance of claim 12, wherein the single camera comprises a wide-angle curvilinear lens.
